(19) United States
(12) Patent Application Publication
(10) Pub. No.: US 2019/0258609 A1
(43) Pub. Date: Aug. 22, 2019

(54) METHOD FOR AVOIDING FILE DEADLOCK DURING CONCURRENT ACCESS OF A SQLITE DATABASE

(71) Applicant: Shenzhen Kemai Technology Co., Ltd., Shenzhen (CN)

(72) Inventors: Jinyuan Zou, Shenzhen (CN); Hongliang Chen, Shenzhen (CN)

(21) Appl. No.: 16/404,790

(22) Filed: May 7, 2019

Related U.S. Application Data
(63) Continuation of application No. PCT/CN2017/076654, filed on Mar. 14, 2017.

(30) Foreign Application Priority Data
Dec. 22, 2016 (CN) 201611199734.2

(51) Int. Cl. G06F 16/176; G06F 9/52

(52) U.S. Cl. CPC G06F 16/1774; G06F 9/524

(57) ABSTRACT

A method for avoiding file deadlock during concurrent access of a sqlite database is disclosed, wherein, in a software design stage, divide the client sqlite database from one into two or more, and each sqlite database is corresponding to the requirement of a certain type of writing operation of the software system. Respectively classify all the data tables used in the software according to the different types of writing operation and place them in different sqlite database files. This could ensure that different types of writing operations are respectively corresponding to different files, and when multiple threads of the application software generate writing operations at the same time, since they respectively write into different physical disk files, so as to avoid the problem that one sqlite database file cannot be concurrently written by multiple threads at the same time.

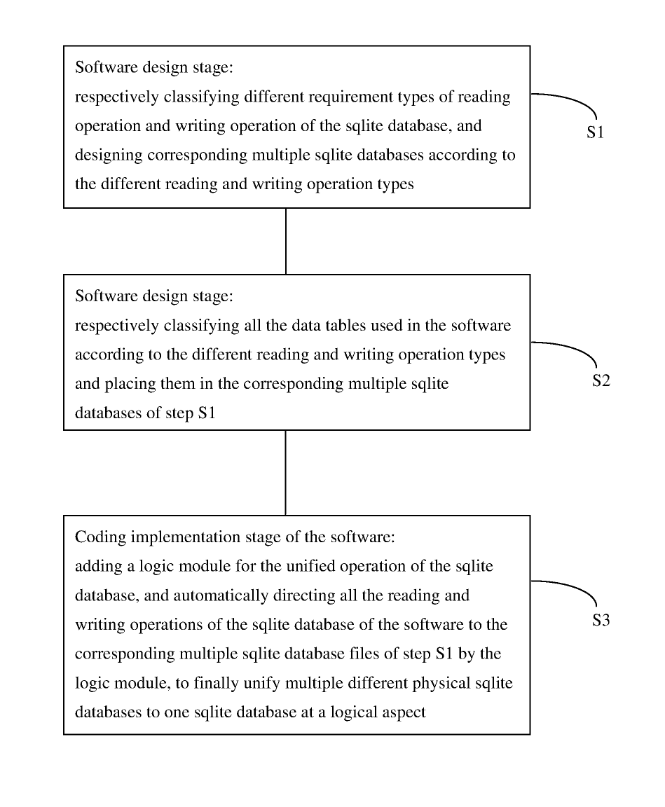

### CROSS REFERENCE TO RELATED APPLICATION

The present application is a continuation application of PCT/CN2017/076654, filed on Mar. 14, 2017, which claims the benefit of Chinese Patent Application No. 201611199734.2 filed on Dec. 22, 2016. All the above are hereby incorporated by reference.

### FIELD OF THE INVENTION

The present application relates to the field of database, and more particularly, to a method for avoiding file deadlock in a commercial application software when a sqlite database is concurrently accessed.

### BACKGROUND OF THE INVENTION

As a small relational database commonly used on various operating system platforms, sqlite is widely applied on PC, mobile phone, tablet and other mobile device. However, in an actual project, data usually needs to be exchanged between the sqlite database and the remote sever. As a file database, sqlite doesn't have the ability of being concurrently written by multiple threads, and it does not have the complex transaction and lock mechanism provided by large relational databases (such as oracle, sybase, sqlserver, etc.) to solve this problem. Therefore, in the actual development process of an application software, there is usually a problem: when a client is writing data to a local sqlite database due to the user's operation, if the sqlite database is performing a bidirectional data exchange operation with a remote server at the same time, the data exchange operation will not normally work since the sqlite database has been locked, and this problem occurs more frequently in a multi-threaded environment.

In most application software, writing operation to the sqlite comes from two needs:

a, the user's operation result (for example, the user enters new data) needs to be written into the sqlite to save.

b, the server has new data which needs to be synchronized to the client's sqlite database.

Among the above two needs, the time and frequency of occurrence of operation b could be controlled inside the software system, and the time and frequency of occurrence of operation a are random (users can operate at any time, not predictable), therefore it is inevitable that operation a and operation b attempt to write to the sqlite database at a same time, and if this happens, it will cause the software system to break down.

Currently, most commercial application software commonly use one or more methods to solve the problem:

1, reduce the frequency of data exchange between the server and the client as far as possible, so as to reduce the probability of concurrent writing.

2, use a cache mechanism for the writing operation to the sqlite database, that is, cache the data in a memory before being written, and when it is detected that the sqlite database file has been locked by other thread, wait until the lock is released before performing the writing operation.

The two solutions commonly used to solve the conflict of sqlite concurrent writing have certain defects.

The defect of the first solution lies in:

One, reducing the frequency of data exchange only reduces the occurrence probability of conflict, but it cannot stop the conflict and does not solve the problem fundamentally.

Two, the solution is at the cost of sacrificing the data consistency between the client and the server during a period of time, and in some household or entertainment products, the influence of this defect is not serious, however, in a commercial software system, the defect often brings inconvenience to the user's use, even generates serious consequence such as data error.

The defect of the second solution lies in:

One, it greatly increase the difficulty of the software design and development, thereby increasing the cost of the software development and decreasing the stability of the system.

Second, using the caching mechanism means the data is actually delayed to be written to the sqlite database, and if an accident (force majeure factors, for example, the client computer loses power supply) occurs to cause the program end abnormally during this period, it will cause the cached data to be lost, and the user will consider that the data has been saved successfully. In the commercial application software, the user's business data is usually very important, so this situation is not allowed.

### SUMMARY OF THE INVENTION

The present application provides a method for avoiding file deadlock during concurrent access of a sqlite database in a commercial application software, which aims to ensure that the client sqlite database does not conflict with data writing generated by the user's software operation when exchanging data with the server at high frequency, and does not significantly increase the complexity of the development of the application software.

The present application provides a method for avoiding file deadlock during concurrent access of a sqlite database, comprising the following steps:

S1: in a software design stage, respectively classifying different requirement types of reading operation and writing operation of the sqlite database of the software, and designing corresponding multiple sqlite databases according to the different reading and writing operation types;

S2: in the software design stage, respectively classifying all the data tables used in the software according to the different reading and writing operation types and placing them in the corresponding multiple sqlite databases of step S1;

S3: in a coding implementation stage of the software, adding a logic module for the unified operation of the sqlite database, and automatically directing all the reading and writing operations of the sqlite database of the software to the corresponding multiple sqlite database files of step S1 by the logic module, to finally unify multiple different physical sqlite databases to one sqlite database at a logical aspect.

Divide the client sqlite database from one into two or more, and each sqlite database is corresponding to the requirement of a certain type of writing operation of the software system. For most software system, divide into two sqlite databases, and one is used for writing data when the user operates in the software system, and the other is used for writing data when the client exchanges data with the server. The result of this is to divide one sqlite database file originally on the disk into multiple files, and change the limit that one file is written only by one thread at the same time to that at the same time multiple threads could write into different files, so as to fundamentally solve the problem of the file writing conflict of the sqlite database.

Classify all the data tables of the software system according to different types of writing operations, and place them in different sqlite database files. This could ensure that different types of writing operations are respectively corresponding to different sqlite database files, and when multiple threads of the application software generate writing operations at the same time, since they separately writes into different files, thereby avoiding the problem that one sqlite database file cannot be simultaneously written by multiple threads.

The beneficial effects of the method for avoiding file deadlock during concurrent access of a sqlite database of the present application are:

1, fundamentally solve the conflict problem that one sqlite database cannot be simultaneously written by multiple threads at the same time, and compared with the above mentioned similar method (reducing the frequency of data exchange between the server and the client), the method has no principle loophole, that is: no matter how high the frequency of the data exchange between the client sqlite database and the server (as long as it is within the file writing speed limit of the disk) is, the sqlite database will not conflict with the writing operation generated when the user operates the software system.

2, compared with the above mentioned method (using a caching mechanism for the writing operation to the sqlite database), the method does not generate a delay time when writing data, and thus there is no side effect such as the loss of user data.

3, compared with the above mentioned method (using the caching mechanism for the writing operation to the sqlite database), the implementation of the method is relatively simple (only need to classify different types of reading and writing operation at the design stage and the encoding stage), does not involve the complex technology needed when implementing the caching mechanism and the extra code for ensuring the safety and effectiveness of the cached data.

### BRIEF DESCRIPTION OF THE DRAWINGS

The sole FIGURE is a flow chart of a method for avoiding file deadlock during concurrent access of a sqlite database of the present application;

The implementation of the aim, functional features and advantages of the present application will be further described in conjunction with the embodiments and with the reference to the accompanying drawing.

### DESCRIPTION OF THE EMBODIMENTS

It should be understood that, the embodiments described herein are merely intended to illustrate the present application, and are not used to limit the present application.

Referring to the sole FIGURE, a method for avoiding file deadlock during the concurrent access of a sqlite database of the present application is illustrated, and the steps are as follows:

S1, in a software design stage, respectively classifying different requirement types of reading operation and writing operation of the sqlite database of the software, and designing corresponding multiple sqlite databases according to the different reading and writing operation types;

S2, in the software design stage, respectively classifying all the data tables used in the software according to the different reading and writing operation types and placing them in the corresponding multiple sqlite databases of step S1;

S3, in a coding implementation stage of the software, adding a logic module for the unified operation of the sqlite database, and automatically directing all the reading and writing operations of the sqlite database of the software to the corresponding multiple sqlite database files of step S1 by the logic module, to finally unify multiple different physical sqlite databases to one sqlite database at a logical aspect.

In the software design stage, divide the client sqlite database from one into two or more, and each sqlite database is corresponding to the requirement of a certain type of writing operation of the software system. For most software systems, divide into two sqlite databases, and one is used for writing data when the user operates in the software system, and the other is used for writing data when the client exchanges data with the server.

The result of this is to divide one sqlite database file originally on the disk into multiple files, and change the original limit that one file is written only by one thread at the same time to that at the same time multiple threads could write into different files, so as to fundamentally solve the problem of the file writing conflict of the sqlite database.

Classify all data tables of the software system according to different types of writing operations, and place them in different sqlite database files. This could ensure that different types of writing operations are respectively corresponding to different sqlite database files, and when multiple threads of the application software generate writing operations at the same time, since they separately writes into different files, thereby avoiding the problem that one sqlite database file cannot be simultaneously written by multiple threads.

After the actual verification in the customer environment, after the software system adopts this method, the data exchange frequency between the client sqlite database and the server could reach 1-15 seconds once (this time may be different depending on the user's data and network condition), and the effect of the silent operation could also be achieved by placing the data exchange operation in the sub-thread, so as not to have any influence on the user's use of the software. For commercial application software, this frequency is basically equivalent to that the client's data and the server's data are kept in immediate synchronization, greatly improving the user's experience.

The above description is only the preferred embodiments of the present application, and is not intended to limit the protection scope of the present application, and any equivalent structural transformations made by the specification and drawings of the present application, or directly or indirectly application in other related technical fields, should all fall into the protection scope of the present application.

What is claimed is:

1. A method for avoiding file deadlock during concurrent access of a sqlite database, comprising the following steps:
S1: in a software design stage, respectively classifying different requirement types of reading operation and writing operation of the sqlite database of the software, and designing corresponding multiple sqlite databases according to the different reading and writing operation types;
S2: in the software design stage, respectively classifying all the data tables used in the software according to the different reading and writing operation types and placing them in the corresponding multiple sqlite databases of step S1;
S3: in a coding implementation stage of the software, adding a logic module for the unified operation of the sqlite database, and automatically directing all the reading and writing operations of the sqlite database of the software to the corresponding multiple sqlite database files of step S1 by the logic module, to finally unify multiple different physical sqlite databases to one sqlite database at a logical aspect.
